(19) United States
(12) Patent Application Publication
(10) Pub. No.: US 2005/0209722 A1
(43) Pub. Date: Sep. 22, 2005

(54) System and method for automating architecture changes to system-level design

(75) Inventors: Raymond G.H. Kok, Eindhoven (NL); Timothy A. Kelker, Liberty Township, OH (US)

Correspondence Address: DOCKET CLERK, PO BOX 800889, DALLAS, TX, 75380, US

(73) Assignee: UGS Corp., Plano, TX (US)

(21) Appl. No.: 10/931,935

(22) Filed: Sep. 1, 2004

Related U.S. Application Data
(60) Provisional application No. 60/554,546, filed on Mar. 19, 2004.

(51) Int. Cl. G06F 19/00

(52) U.S. Cl. 700/105; 700/104

(57) ABSTRACT

A system and method for the automation of architectural changes to a system level design process. Various embodiments of the process include generating product definition templates for each node in a product model, then applying knowledge-based engineering processes and tools in conjunction with interpart modeling functionality to automate the architectural change using the product definition templates.

### CROSS REFERENCE TO RELATED APPLICATIONS

The present application claims priority to U.S. Provisional Patent Application 60/554,546, filed Mar. 19, 2004, which is hereby incorporated by reference.

### TECHNICAL FIELD OF THE INVENTION

The present invention is directed, in general, to computer-aided design systems.

### BACKGROUND OF THE INVENTION

For several years MCAD systems have possessed interpart modeling functionality that facilitate system level design. That is the ability to design an associative system composed of several parametric parts rather than collecting standalone parametric parts into a non-associative system. Current system level design tools achieve associativity by creating several interpart geometric and non-geometric relationships. A completed system will contain hundreds to thousands of these hardwired design specific interpart relationships.

Making an architectural change to one of these systems is a manual process, very complicated and requires a great deal of detailed knowledge given the quantity of hardwired relationships. This has proven to be a major drawback to system level design tools since making architectural changes (what if study) is an important and obvious requirement. The development of a system level design tool capable of automated architectural changes would be an enormous improvement over current technology.

### SUMMARY OF THE INVENTION

A preferred embodiment provides a system and method for the automation of architectural changes to a system level design process. Various embodiments of the process include generating product definition templates for each node in a product model, then applying knowledge-based engineering processes and tools in conjunction with interpart modeling functionality to automate the architectural change using the product definition templates.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which a preferred embodiment can be implemented;

FIG. 2 shows geometric and parametric interfacing with Product Definition Templates (PDT), in accordance with an embodiment of the present invention;

FIG. 3 shows an example of jet engine system-level structure, including various component parts;

FIG. 4 shows an example of using a Product Definition Template in jet engine example, showing geometric and parametric associations;

FIG. 5 depicts a flowchart of a process in accordance with a preferred embodiment; and

FIG. 6 depicts a partial example of an aircraft “light” product structure in accordance with a preferred embodiment.

### DETAILED DESCRIPTION OF THE INVENTION

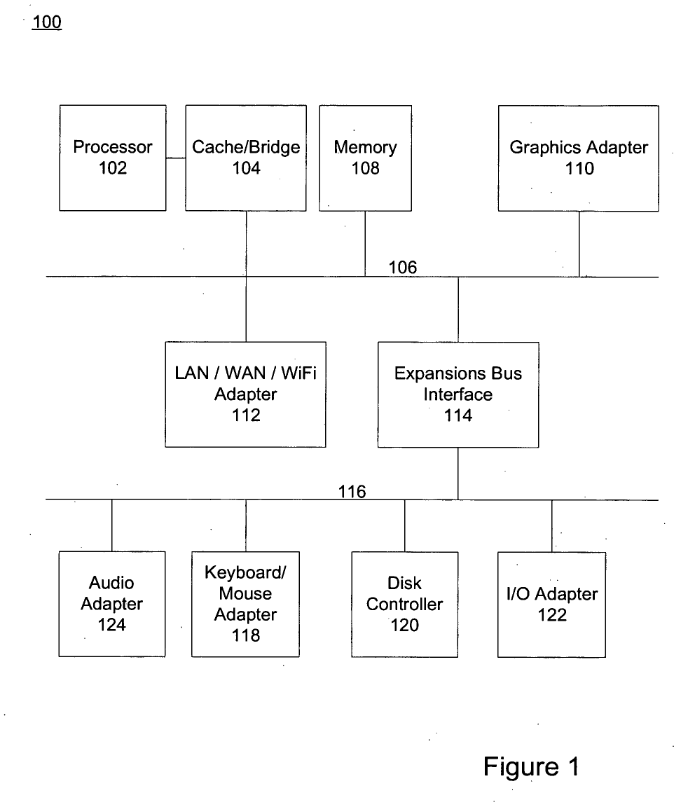

FIGS. 1 through 6 discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

FIG. 1 depicts a block diagram of a data processing system in which a preferred embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

One embodiment of the present invention enables the automation of architectural changes to a system level design process by combining Knowledge-Based Engineering (KBE) & interpart modeling functionality. A preferred embodiment includes system and method for the automation of architectural changes to a system level design process. Various embodiments of the process include generating product definition templates for each node in a product model, then applying knowledge-based engineering processes and tools to automate the architectural change using the product definition templates.

One known product that uses interpart modeling functionalities is Unigraphics NX2, which is widely used by high-tech customers in order to build associative and parametric system level design models. The Unigraphics interpart modeling functionality itself is already capable of propagating design changes from the top level of the associative modeling structure to the actual solid model part files. Unigraphics NX2 can be used with the KBE tool Knowledge Fusion. Unigraphics NX Wave includes core functionality to associatively copy geometry between parts and to enable the automation of design changes resulting from modifications to related parts. While various examples and embodiments are described herein with regard to Unigraphics NX2, Unigraphics NX Wave, and Unigraphics NX Knowledge Fusion, those of skill in the art recognize that the disclosed and claimed features can be applied to other interpart modeling and knowledge-based engineering tools and applications.

Experience has shown that easily changing a classical interpart structure is only possible when the groundwork of the current architecture is not drastically changed. When companies need to revise a part which is a member of the system level control structure then one has to be sure that this element can get instantiated in the current system level control structure, i.e. it has to keep form, fit, and function. This means that when you want to instantiate a specific engine design you can either clone & morph an existing system level control structure and change it in the way the engineer desires it or bring in architectural changes by using the suppression by expression functionality. This last option will cause considerable problems as we move to larger structures as one will loose the overview of the current options to suppress or unsuppress different chunks of the available geometry.

Modifying an existing system level product structure to a new product program is neither fast nor easy according to conventional methods. The system level product structure for each product is slightly different & modifying it while maintaining control of the hundreds of part files & over a thousand interfaces has proven difficult. Even with this difficulty, companies are saving time & money with the classical interpart modeling approach, it would be advantageous to eliminate this time consuming and highly manual reconfiguration process.

To establish configuration changes within a system level product structure, the disclosed embodiments are used to track the different configurations and how the different sub-elements of the product structure are related to each other for each possible design configuration. The disclosed embodiments not only control the different configurations of the system level control structure in addition it will drive the parametric scaling of the different subsystems of the product design.

Upon examination of the different sub-elements of the control structure, one sees that these elements can be regarded as stand-alone working pieces of the total engine design. Such sub-elements of the overall control structure can live in context when geometric and parametric information from the global structure is fed to the different sub-systems.

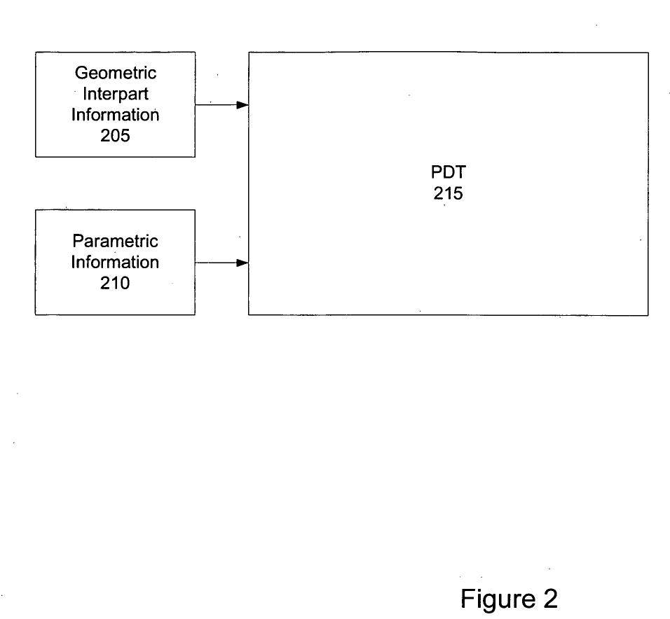

FIG. 2 shows geometric and parametric interfacing with Product Definition Templates (PDT), in accordance with an embodiment of the present invention. Geometric interpart information 205, which includes interfaces with other sub-elements, interfaces with PDT 215. Similarly, parametric information 210, which includes scaling information, also interfaces with PDT 215.

Product Definition Templates are particularly useful when one needs a certain level of detailed engineering in order to create the appropriate solid model component, and interfacing is required between the system-level description of the product and this solid model component. Such a Product Definition Template contains the detailed description of the specific component without having the complexity of writing these details inside the Knowledge Fusion or other particular KBE tool syntax. Some disclosed embodiments include a product component library that includes Product Definition Templates for each functional element of given product.

With the help of the PDT application, a user can bring these templates in context and change them parametrically in order to fit the corresponding assembly context. The internal logic manages the backbone data stream that brings the different templates into context of the overall engineering model.

Interpart modeling mixed with Knowledge Based Engineering (KBE): In order to facilitate this Product Definition Template application, a backbone structure, is used to bring all the different Product Definition Templates into context of each other. In a preferred embodiment, this backbone is fully built with the Knowledge Fusion technology and provides the hooks to each of the Product Definition Templates along with geometric and parametric relations to the rest of the engineering model in order to size the specific templates. Of course, in other embodiments, other KBE tools can be utilized

This means that all the layers of the control structure, which mainly contain geometrical entities meant to interface between different levels in the product control structure, are fully controlled by KBE rules. In some embodiments, the geometrical description of each part within the control structure is described with the KF rules; together with the links that bring all the different components in context of each other.

Consider the following example from a jet engine in which we use a PDT structure in order to cover the Compressor_Rotor_stage_{—}1 sub-system component inside a system-level product structure:

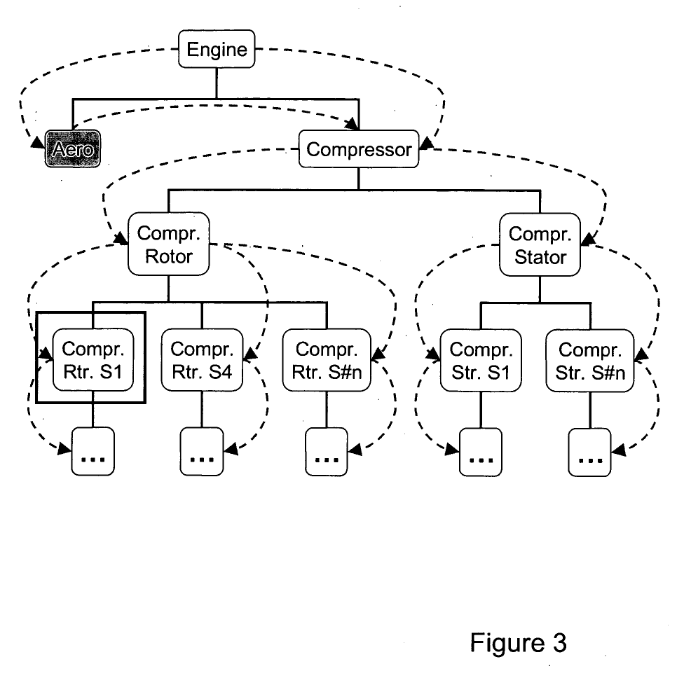

FIG. 3 shows an example of jet engine system-level structure, including various component parts. A description of each component and their interrelations is not essential to enable an understanding of the claimed embodiments.

In examining the Product Definition Template itself, it is clear that external hook-ups to the rest of the engineering model are needed to bring it in context. Consider the component “compressor-rotor stage 1” which has x interpart links to the parent level inside the control structure. It is possible to control these links from outside the parent level, that is, when constructing the control structure, the user is able to re-parent the different Product Definition Templates with conditional statements. This can be achieved by “adopting” the corresponding WAVE links, which brings them in control of Knowledge Fusion or other KBE tool.

Aside from the geometrical interfaces, the preferred embodiment also provides the ability to control the parametric context of the different Product Definition Templates. The same mechanism described above is used with the geometrical interfaces, adopting the corresponding features and control the parameters with the help of Knowledge Fusion. This can be done in two ways; directly control the values from the parent level with the ug_child_in_part mechanism or using an intermediate class as described above.

The preferred embodiment uses an intermediate class that acts as a universal adaptor to the rest of the engineering model.

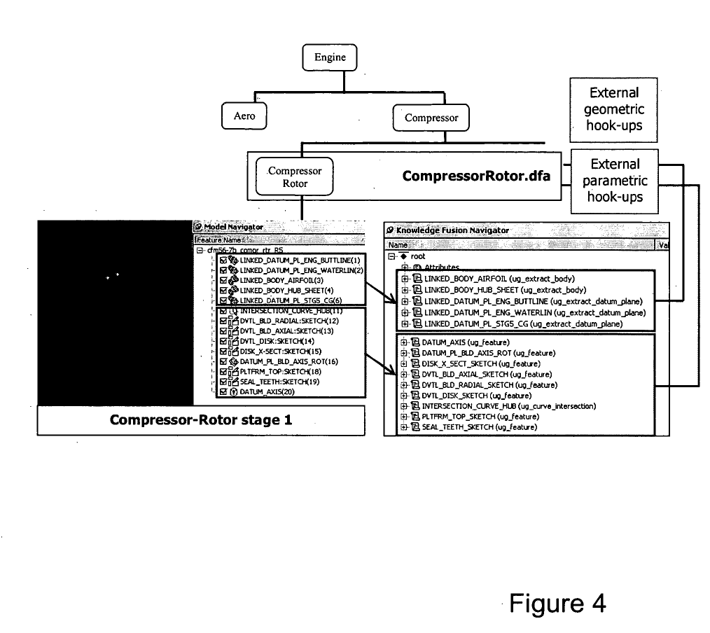

FIG. 4 shows an example of using a Product Definition Template in jet engine example, showing geometric and parametric associations.

In this modular architecture, environment in which one supervising KF class is created to bring the different Product Definition Templates in context with each other. This also acts as a configuration engine for preliminary design team. As described below, one embodiment includes a GUI on top of the supervision KF class that can propose a specific control structure for the preliminary design team. One can pass in the general requirement for the aircraft engine and it will propose a specific control structure; # of stages, axial or radial disks, etc.

Notice that this architecture, if necessary, can be used in conjunction with the full generative approach. When certain Product Definition Templates turn out to be fully controlled by engineering rules then the user can still decide to switch over to the generative approach and write a generative module instead of a Product Definition Template. Because of the modular approach, the user can decide to give each sub-element in the control structure a dedicated UI when necessary or use the classical interfaces like sketching and expressions to have local control of the parameters. A switch should determine whether the specific module is driven by the context of the engineering model or locally controlled within the part file.

As said, a control structure makes it possible to morph a product automatically, however it does not provide enough flexibility to change the configuration. The PDT approach can easily achieve this flexibility by utilizing both KBE and interpart modeling tools.

Individual PDT's, like a “wing rib” in an airframe example, are very powerful building blocks. They contain very detailed geometry with complex geometric relationships, which are typically very difficult to generate in a pure KBE environment, but can have their size, shape and position automatically modified by the KF controlled external inputs (geometric & non-geometric). This unique combination results in the best of both worlds—using interpart modeling and CAD tools to create, modify and update complex geometry, while still maintaining the automation and flexibility of a knowledge-based engineering tool.

PDT Structure Overview: A particular advantage of the disclosed PDT process is achieved by creating a system-level structure from individual PDT's. A “business jet” will once again serve as an example for demonstrating how the PDT process is utilized to create a system level design structure.

As stated above, the system level structure produced by the PDT process will appear to be very similar to the structure described above, but the following example will demonstrate that there is much more. When every individual node of the structure is viewed as a PDT instead of individual part file, the flexibility of the structure becomes apparent. For example, the size, shape and location of a wing Rib PDT is fully dependent upon the geometric & non-geometric data defined in an Aircraft PDT and Wing PDT. Thus the wing Rib PDT will update to the KF inputs coming from its parent PDT files, within reasonable limits. Apply this logic to every node of the structure and the advantages of the PDT process are great.

The strength of this process is further increased when every individual node of the structure is viewed as one member of a PDT library instead of one specific PDT. The “rib” PDT selected for inclusion in the exemplary structure will be chosen over the other ribs in the library based on the requirements of the current structure. Thus every node of the structure can have a different size, shape and position based on the specific PDT chosen from the library & this in turn impacts the size, shape and position of all dependent PDT's. Once again, apply this logic to every node of the structure and the power and flexibility of the PDT process is obvious.

Making Major Configuration Changes With The PDT Process: As described above, the PDT process allows for automated configuration changes. There are several ways to accomplish this but the best way is to imbed the PDT process in a complete application controlled by KF, referred to herein as “the backbone.” For the business jet, and all applications, the first step would be to collect user input, and an ideal way to present and gather this input is via an interactive GUI interface.

Once the above criteria are known, the application has enough information to begin building the desired system level design structure. The KBE code will execute a series of logic statements and thus identify the basic configuration needed for the structure—modules required, number of levels required, specific PDT's required for each node, quantity of PDT's, inputs required for all linked geometry, required non-geometric inputs . . . .

Running the application with different input will result in very different aircraft design. So the PDT process can deliver major configuration changes in a design system by simply modifying inputs to the application.

Maintaining System Level Control With The PDT Process: If the PDT process only improved the ability to make configuration changes it would be a partial solution. One value of the PDT process is that in addition to facilitating configuration changes the resulting structure maintains all interpart relationships so system level modification (design “what-if's”) can still be performed. The wing of the business jet makes an ideal example for this.

In this example, the sweep angle of the wing will be increased, a common system level change for aircraft design, and all dependent geometry will automatically update. Specifically all the interior wing components (ribs, spars, stringers . . . ) and the joint between the wing and fuselage will all update appropriately.

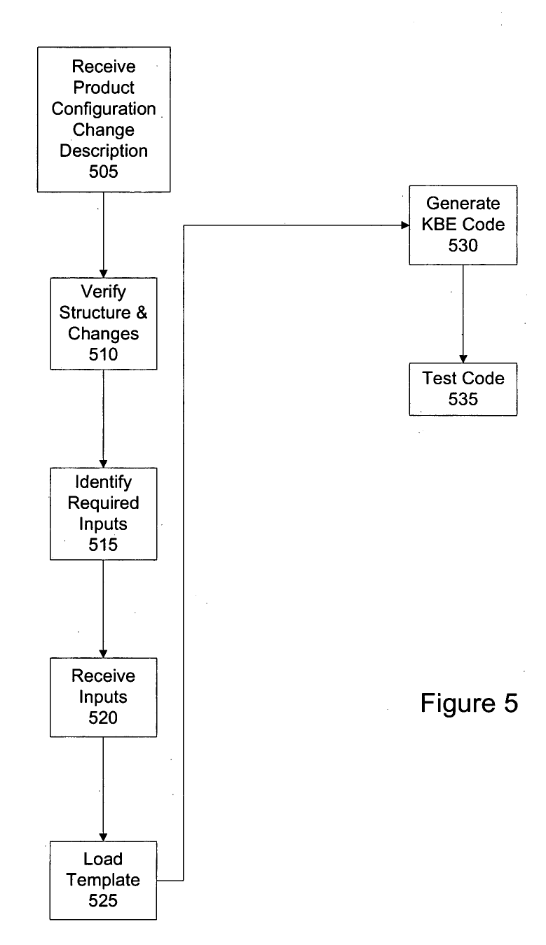

FIG. 5 depicts a flowchart of a process in accordance with a preferred embodiment.

First, the user (or a group of users) will identify the desired “product” configurations, and how the system will accommodate these configurations (step 505).

Next, the users will verify that the identified structure can accommodate the desired configuration changes (step 510). In other embodiments, this process is performed by the system.

The system will then identify the required system level inputs according to the product and components involved in the configuration change (step 515).

The required system level inputs will be displayed, typically in a graphical user interface, user will be able to set inputs, and the system will collect all inputs (step 520)

The system includes a library of PDTs, preferably including one for every node (part file) in the existing structure, and loads at least one of these (step 525). These PDTs are created by converting product model nodes into corresponding product design templates, in a one-time process. Note that some part files near the “top” of the structure may contain such simple geometry that these files can be generated via the KBE tool instead of converted to a PDT.

Next, all the necessary KBE code is generated to make system level decisions, identify appropriate PDT's, create assembly structure, re-parent all linked geometry and drive desired non-geometric inputs (step 530) This process is performed by a user in the preferred embodiment, and is automated in other embodiments, using techniques known to those of skill in the art.

The system will then, with user interaction, run and test the application, fix and problems found, and repeat as necessary (step 535).

Given the above detailed explanation of how various PDT embodiments work and the knowledge they contain, one can easily see that PDT's can be utilized to automatically configure and validate “light” product structures completely independent of a CAD system. This “light” product structure can simply be a graphical representation and lack the detail geometric definition that is contained in a full product structure. The main advantages of this “light” product structure is its speed of creation, generic representation and compatibility with all organizations within a company.

An expert system ‘backbone’ contains the rules and logic for determining which specific PDTs should be selected from the library given certain input parameters. The individual PDT's know exactly what feature types are required for their input. All the decisions necessary for configuring a product structure can be made once these two pieces of information are understood.

Regardless of a company's configuration, or the product they produce, the product structure drives many decisions. The traditional process for creating a valid product structure often takes weeks, months or years. Given this very long lead time companies are often forced to make several important decisions before the product structure is fully understood and it makes it virtually impossible to optimize/iterate on a product structure.

The utilization of the PDT process can easily convert the week, months or years into minutes. This rapid turn-around allows a product structure generation tool to be utilized much sooner in the design process and makes it available to everyone in the company.

The first step to the creation of a product structure using this “light” process is the gathering of data. The user enters several parameters that define the desired product. This interface is preferably a GUI interface as known to those of skill in the art and described herein.

Once this data is collected, expert system will identify all the required PDTS, from the PDT library, needed to create the desired product. Once the PDTs are identified, the compatibility of inputs & outputs between corresponding PDTs is verified.

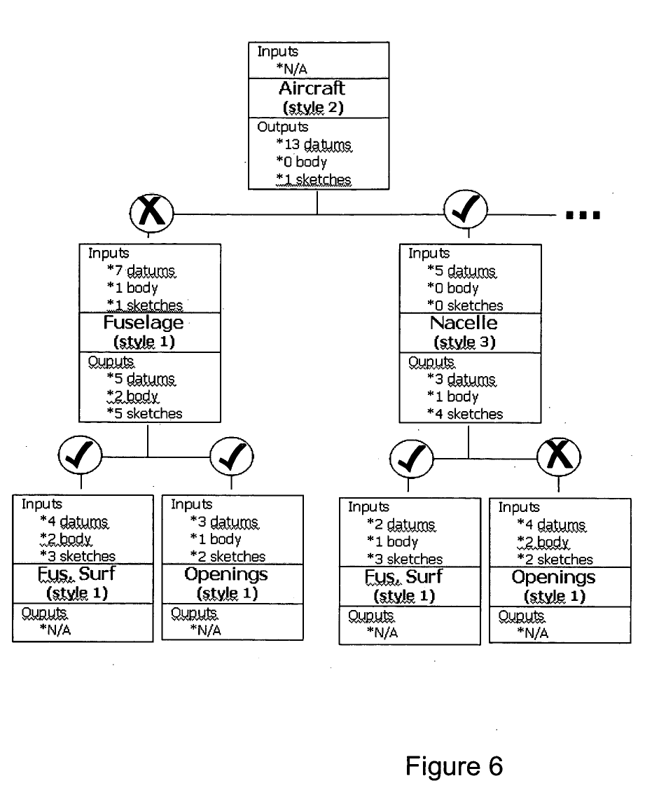

The above data can then be displayed in a simple, easy to understand format. FIG. 6 depicts a partial example of an aircraft “light” product structure.

In FIG. 6, the “checked” circles represent valid product structure relationships, where the parent file provides adequate outputs to the child file, and the “Xed” circles represent invalid relationships. The data in the chart of FIG. 6 easily identifies the problem areas with the desired product. The user then only has to modify the inputs to achieve a valid product structure. In alternate embodiments, the application makes suggestions as to how the conflicts could be resolved.

During the design cycle of a product there are several groups/organizations (marketing, sales, preliminary design, engineering, manufacturing, etc.) that require valid product structures to be generated quickly but lack the skill set or time necessary to generate a traditional product structure. They may lack the product knowledge, engineering skill, detail design knowledge or experience running the engineering tools (i.e. CAD system). Or they simply can not invest the days, weeks or months it would normally take to create a traditional product structure. Using a “light” tool as described in the above embodiments, a marketing, sales or engineering person can quickly develop a product structure with common everyday office tools, they could better respond to the needs of their customers.

In various embodiments, this product structure can automatically generate approximate common high level outputs—weight, cost, part count, verify structure validity.

Alternate and less preferred embodiments include a PDT like tool for a specific product like reciprocating engines. This tool would function very well for reciprocation engine design but since it is customized it would have two distinct limitations—flexibility & associativity. The PDT application is based on fundamental imbedded functionality that can easily be adapted to any product design. The customized approach is preferably limited to a given product and difficult for customers to modify. Likewise, since the PDT application is built on imbedded functionality there is a high level of associativity between tools. It would be impossible for a customized application to achieve this same level of associativity.

The Product Definition Template system and method, as described herein, promotes reuse of existing structures and makes system level design iterations a real possibility, both of which save customers time, money & resources.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A method for automating architecture changes to a system-level design, comprising:
receiving a change description input corresponding to a product design;
identifying required inputs corresponding to the change description input;
receiving input data corresponding to the required inputs;
identifying at least one product design template corresponding to the input data; and
generating knowledge-based engineering code, using the at least one product design template, according to the change description input and the input data.

2. The method of claim 1, further comprising testing the knowledge-based engineering code.

3. The method of claim 1, further comprising displaying a validation output corresponding to the knowledge-based engineering code.

4. The method of claim 1, further comprising creating a library of product design templates by converting product model nodes into corresponding product design templates.

5. The method of claim 1, further comprising loading at least one product design template from a library of product design templates.

6. The method of claim 1, further comprising verifying the change description input.

7. A data processing system having at least a processor and accessible memory, comprising:
means for receiving a change description input corresponding to a product design;
means for identifying required inputs corresponding to the change description input;
means for receiving input data corresponding to the required inputs;
means for identifying at least one product design template corresponding to the input data; and
means for generating knowledge-based engineering code, using the at least one product design template, according to the change description input and the input data.

8. The data processing system of claim 7, further comprising means for testing the knowledge-based engineering code.

9. The data processing system of claim 7, further comprising means for displaying a validation output corresponding to the knowledge-based engineering code.

10. The data processing system of claim 7, further comprising means for creating a library of product design templates by converting product model nodes into corresponding product design templates.

11. The data processing system of claim 7, further comprising means for loading at least one product design template from a library of product design templates.

12. The data processing system of claim 7, further comprising means for verifying the change description input.

13. A computer program product tangibly embodied in a machine-readable medium, comprising:
instructions for receiving a change description input corresponding to a product design;
instructions for identifying required inputs corresponding to the change description input;
instructions for receiving input data corresponding to the required inputs;
instructions for identifying at least one product design template corresponding to the input data; and
instructions for generating knowledge-based engineering code, using the at least one product design template, according to the change description input and the input data.

14. The computer program product of claim 13, further comprising instructions for testing the knowledge-based engineering code.

15. The computer program product of claim 13, further comprising instructions for displaying a validation output corresponding to the knowledge-based engineering code.

16. The computer program product of claim 13, further comprising instructions for creating a library of product design templates by converting product model nodes into corresponding product design templates.

17. The computer program product of claim 13, further comprising instructions for loading at least one product design template from a library of product design templates.

18. The computer program product of claim 13, further comprising instructions for verifying the change description input.
